(19) United States
(12) Patent Application Publication
(10) Pub. No.: US 2012/0105657 A1
(43) Pub. Date: May 3, 2012

(54) IMAGE PROCESSING APPARATUS, IMAGE PICKUP APPARATUS, IMAGE PROCESSING METHOD, AND PROGRAM

(75) Inventors: Masahiro YOKOHATA, Osaka City (JP); Haruo HATANAKA, Kyoto City (JP); Shinpei FUKUMOTO, Higashiosaka City (JP)

(73) Assignee: SANYO Electric Co., Ltd., Moriguchi City (JP)

(21) Appl. No.: 13/284,887

(22) Filed: Oct. 29, 2011

(30) Foreign Application Priority Data
Oct. 29, 2010 (JP) 2010-243196

(51) Int. Cl. H04N 5/225; G06K 9/36

(52) U.S. Cl. 348/208.4; 382/282; 348/E05.046

(57) ABSTRACT

An image processing apparatus includes a region setting portion that sets a clipping region as an image region in each input image based on image data of an input image sequence consisting of a plurality of input images, a clipping process portion that extracts an image within the clipping region as a clipped image from each of a plurality of target input images included in the plurality of input images, and an image combining portion that arranges and combines a plurality of clipped images that are extracted.

### CROSS-REFERENCE TO RELATED APPLICATIONS

This nonprovisional application claims priority under 35 U.S.C. §119(a) on Patent Application No. 2010-243196 filed in Japan on Oct. 29, 2010, the entire contents of which are hereby incorporated by reference.

### BACKGROUND OF THE INVENTION

1. Field of the Invention

The present invention relates to an image processing apparatus, an image processing method, and a program, which perform image processing. In addition, the present invention relates to an image pickup apparatus such as a digital camera.

2 Description of Related Art

There is proposed a method of generating an image as illustrated in FIG. 26 by clipping a moving target object from each frame of a moving image 900 as illustrated in FIG. 25 and by overlaying images of the clipped target object in order on a background image. This image is called a stroboscopic image (or strobe light image) and is used for checking form in sport or the like. FIG. 26 illustrates the stroboscopic image in which a person as the target object is swinging a golf club. In FIG. 26 and FIG. 27 referred to later, a part with hatching indicates a casing part of a display apparatus that displays the stroboscopic image or the like.

In addition, there is also proposed a method in which the display screen is divided into a plurality of display regions, and a plurality of frames constituting the moving image are displayed as multi-display using the plurality of divided display regions as illustrated in FIG. 27.

If the position of the target object is scarcely changed on the moving image in such a case where the target object is a person who swings a golf club, images of the target object at different time points are overlapped on the stroboscopic image as illustrated in FIG. 26, and hence it is difficult to check the movement of the target object.

According to the multi-display method illustrated in FIG. 27, such overlapping of target objects does not occur. However, each display size of the target object is small, and as a result, it is difficult to check the movement of the target object also by the method of FIG. 27.

### SUMMARY OF THE INVENTION

An image processing apparatus according to the present invention includes a region setting portion that sets a clipping region as an image region in each input image based on image data of an input image sequence consisting of a plurality of input images, a clipping process portion that extracts an image within the clipping region as a clipped image from each of a plurality of target input images included in the plurality of input images, and an image combining portion that arranges and combines a plurality of clipped images that are extracted.

An image pickup apparatus according to the present invention, which obtains an input image sequence consisting of a plurality of input images from a result of sequential photographing using an image sensor, includes a vibration correcting portion that reduces vibration of a subject among the input images due to movement of the image pickup apparatus based on a detection result of the movement, a region setting portion that sets a clipping region as an image region on each input image based on the detection result of movement, a clipping process portion that extracts an image within the clipping region as a clipped image from each of a plurality of target input images included in the plurality of input images, and an image combining portion that arranges and combines a plurality of clipped images that are extracted.

An image processing method according to the present invention includes a region setting step that sets a clipping region as an image region on each input image based on image data of an input image sequence consisting of a plurality of input images, a clipping process step that extracts an image within the clipping region as a clipped image from each of a plurality of target input images included in the plurality of input images, and an image combining step that arranges and combines a plurality of clipped images that are extracted.

Further, it is preferred to form a program for a computer to perform the above-mentioned region setting step, the clipping process step, and the image combining step.

### BRIEF DESCRIPTION OF THE DRAWINGS

FIG. 1 is a general block diagram of an image pickup apparatus according to a first embodiment of the present invention.

FIG. 2 is a diagram illustrating a relationship between a two-dimensional image space and a two-dimensional image.

FIG. 3 is an internal block diagram of an image processing portion disposed in the image pickup apparatus illustrated in FIG. 1.

FIG. 4 is an action flowchart of the image pickup apparatus according to the first embodiment of the present invention.

FIG. 5 is a diagram illustrating a structure of an input image sequence.

FIGS. 6A and 6B are diagrams illustrating display screens when selecting a combination start frame and a combination end frame, respectively.

FIG. 7 is a diagram for explaining meanings of the combination start frame, the combination end frame, and a combination target period.

FIG. 8 is a diagram illustrating a manner in which a plurality of target input images are extracted from the input image sequence.

FIG. 9 is a flowchart of a clipping region setting process.

FIGS. 10A and 10B are diagrams for explaining a background image generating process.

FIG. 11 is a diagram illustrating a manner in which a moving object region is detected from each target input image based on a background image and each target input image.

FIGS. 12A to 12E are diagrams for explaining a using method of the detected moving object region.

FIG. 13 is a variation flowchart of the clipping region setting process.

FIG. 14A illustrates a manner in which a clipping region is set in each target input image, and FIG. 14B illustrates a manner in which two clipping regions of two target input images are overlaid on each other.

FIGS. 15A and 15B are diagrams illustrating an example of an output combined image according to the first embodiment of the present invention.

FIG. 16 is a process image diagram of a method of increasing the number of combination.

FIG. 17 is a process image diagram of another method of increasing the number of combination.

FIG. 18 is a diagram illustrating a generating process flow of the output combined image according to the second embodiment of the present invention.

FIG. 19 is a diagram for explaining a scroll display according to the second embodiment of the present invention.

FIG. 20 is a diagram illustrating a manner in which a moving image is formed based on a plurality of scroll images generated for performing the scroll display.

FIGS. 21A and 21B are diagrams for explaining electronic vibration correction according to a third embodiment of the present invention.

FIG. 22 is a block diagram of a portion related to the electronic vibration correction.

FIGS. 23A to 23D are diagrams for explaining a method of setting the clipping region in conjunction with the electronic vibration correction.

FIG. 24 illustrates the clipping regions corresponding to target input images of FIGS. 23A to 23C.

FIG. 25 is a diagram illustrating an example of a moving image according to a conventional technique.

FIG. 26 is a diagram illustrating a manner in which a conventional stroboscopic image is displayed.

FIG. 27 is a diagram illustrating a conventional multi-display screen.

### DETAILED DESCRIPTION OF THE PREFERRED EMBODIMENTS

Hereinafter, examples of embodiments of the present invention are described specifically with reference to the attached drawings. In the drawings to be referred to, the same part is denoted by the same numeral or symbol, and overlapping description of the same part is omitted as a rule.

### First Embodiment

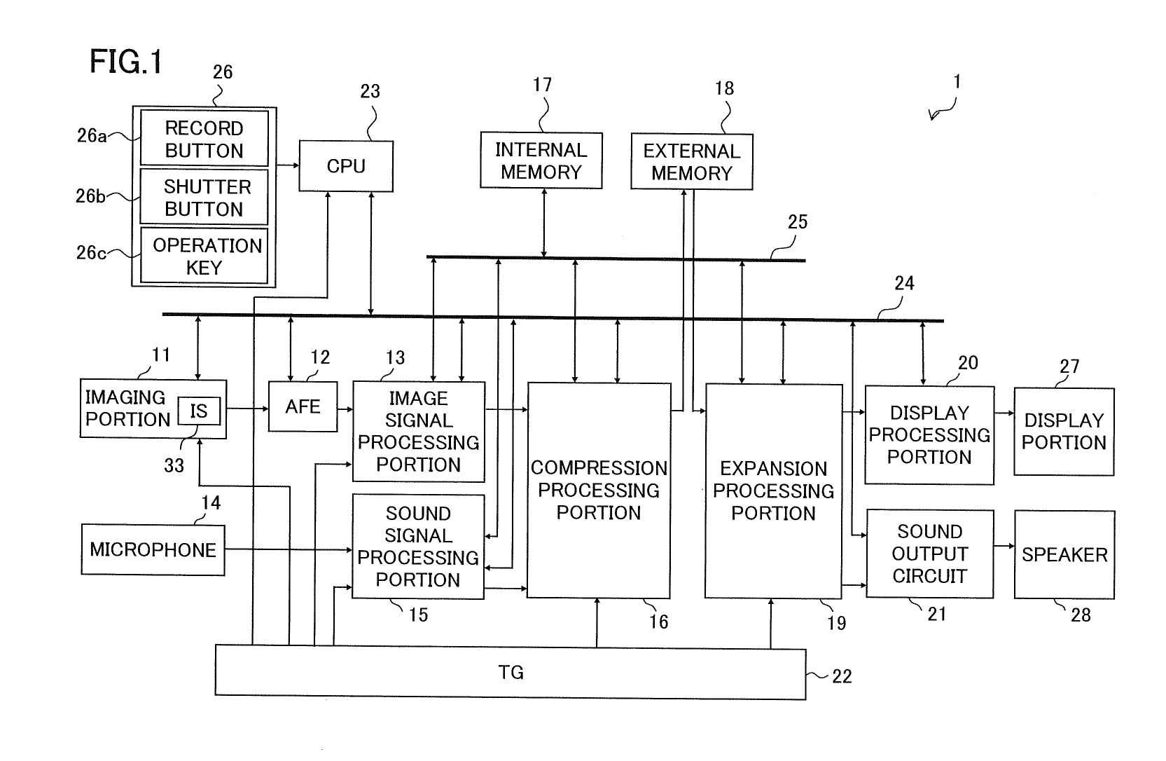

A first embodiment of the present invention is described below. FIG. 1 is a general block diagram of an image pickup apparatus 1 according to the first embodiment of the present invention. The image pickup apparatus 1 includes individual portions denoted by numerals 11 to 28. The image pickup apparatus 1 is a digital video camera, which can photograph moving images and still images, and can photograph a still image during the period while a moving image is photographed. The individual portions of the image pickup apparatus 1 communicate signals (data) among individual portions via a bus 24 or 25. Note that a display portion 27 and/or a speaker 28 may be disposed in an external apparatus (not shown) of the image pickup apparatus 1.

An imaging portion 11 includes, in addition to an image sensor 33, an optical system, an aperture stop, and a driver (not shown). The image sensor 33 is constituted of a plurality of light receiving pixels arranged in horizontal and vertical directions. The image sensor 33 is a solid-state image sensor constituted of a charge coupled device (CCD), a complementary metal oxide semiconductor (CMOS) image sensor, or the like. Each light receiving pixel of the image sensor 33 performs photoelectric conversion of an optical image of a subject entering through the optical system and the aperture stop, and outputs an electric signal obtained by the photoelectric conversion to an analog front end (AFE) 12. Lenses of the optical system form the optical image of the subject on the image sensor 33.

The AFE 12 amplifies an analog signal output from the image sensor 33 (each light receiving pixel) and converts the amplified analog signal into a digital signal, which is output to an image signal processing portion 13. An amplification degree of the signal amplification in the AFE 12 is controlled by a central processing unit (CPU) 23. The image signal processing portion 13 performs necessary image processing on the image expressed by the output signal of the AFE 12 and generates an image signal of the image after the image processing. A microphone 14 converts ambient sounds of the image pickup apparatus 1 into an analog sound signal, and a sound signal processing portion 15 converts the analog sound signal into a digital sound signal.

A compression processing portion 16 compresses the image signal from the image signal processing portion 13 and the sound signal from the sound signal processing portion 15 using a predetermined compression method. An internal memory 17 is constituted of dynamic random access memory (DRAM) and temporarily stores various data. An external memory 18 as a recording medium is a nonvolatile memory such as a semiconductor memory or a magnetic disk, which records the image signal and the sound signal after compression by the compression processing portion 16 in association with each other.

An expansion processing portion 19 expands the compressed image signal and sound signal read out from the external memory 18. The image signal after expansion by the expansion processing portion 19 or the image signal from the image signal processing portion 13 is sent to the display portion 27 constituted of a liquid crystal display or the like via a display processing portion 20 and are displayed as images. In addition, the sound signal after expansion by the expansion processing portion 19 is sent to the speaker 28 via a sound output circuit 21, and is output as sounds.

A timing generator (TG) 22 generates timing control signals for timing control of individual actions in the entire image pickup apparatus 1 and supplies the generated timing control signals to the individual portions of the image pickup apparatus 1. The timing control signals include a vertical synchronizing signal Vsync and a horizontal synchronizing signal Hsync. The CPU 23 integrally controls actions of the individual portions of the image pickup apparatus 1. An operating portion 26 includes a record button 26a for instructing start and finish of photographing and recording a moving image, a shutter button 26b for instructing to photograph and record a still image, an operation key 26c, and the like, so as to accept various operations by a user. The operation with the operating portion 26 is sent to the CPU 23.

Action modes of the image pickup apparatus 1 include a photography mode in which an image (still image or moving image) can be taken and recorded, and a reproduction mode in which the image recorded in the external memory 18 (still image or moving image) is reproduced and displayed on the display portion 27. Transition between the modes is performed in accordance with the operation with the operation key 26c.

In the photography mode, subjects are photographed sequentially, and photographed images of the subjects are obtained sequentially. A digital image signal expressing the image is referred to also as image data.

Note that because compression and expansion of the image data is not essentially related to the present invention, compression and expansion of the image data is neglected in the following description (in other words, for example, to record compressed image data is simply expressed as to record image data). In addition, in this specification, image data of an image may be simply referred to as an image. In addition, in this specification, when simply referred to as a display or a display screen, it means a display or a display screen of the display portion 27.

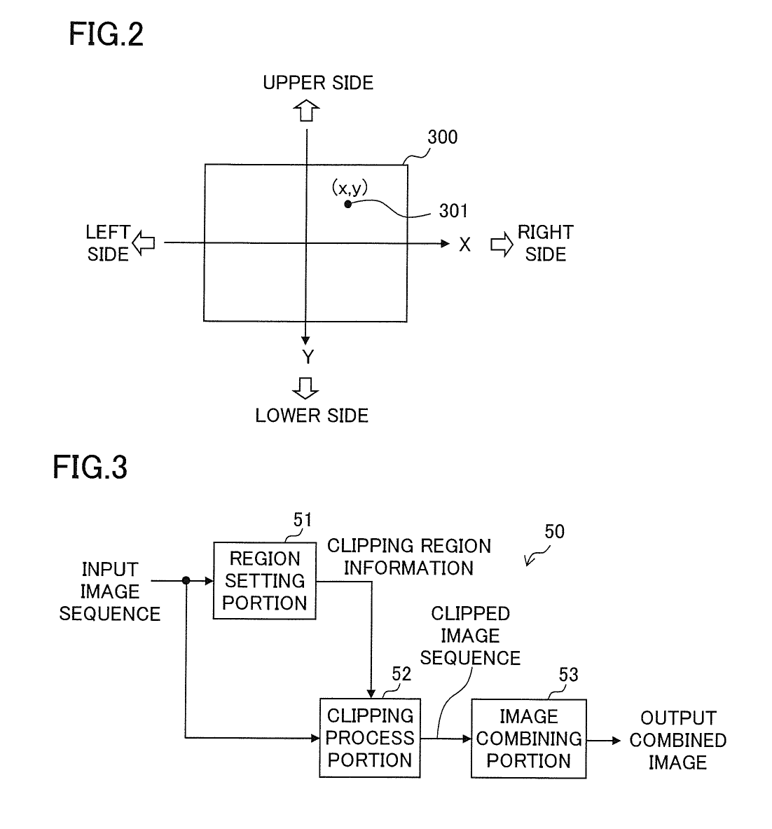

FIG. 2 illustrates a two-dimensional image space XY. The image space XY is a two-dimensional coordinate system on a spatial domain having an X-axis and a Y-axis as coordinate axes. An arbitrary two-dimensional image 300 can be regarded as an image disposed on the image space XY. The X-axis and the Y-axis are respectively along a horizontal direction and a vertical direction of the two-dimensional image 300. The two-dimensional image 300 is constituted of a plurality of pixels arranged in the horizontal direction and in the vertical direction like a matrix. A position of a pixel 301 that is any pixel on the two-dimensional image 300 is expressed by (x, y). In this specification, a position of a pixel is also referred to simply as a pixel position. Coordinate values in the X-axis and the Y-axis directions of the pixel 301 are denoted by x and y. In the two-dimensional coordinate system XY, if a position of a certain pixel is shifted to the right side by one pixel, a coordinate value of the pixel in the X-axis direction is increased by one. If a position of a certain pixel is shifted to the lower side by one pixel, a coordinate value of the pixel in the Y-axis direction is increased by one. Therefore, if a position of the pixel 301 is (x, y), positions of pixels neighboring to the pixel 301 on the right side, on the left side, on the lower side, and on the upper side are expressed by (x+1, y), (x−1, y), (x, y+1), and (x, y−1), respectively.

The image pickup apparatus 1 has an image combining function of combining a plurality of input images arranged in time sequence. FIG. 3 illustrates an internal block diagram of an image processing portion (image processing apparatus) 50 in charge of the image combining function. The image processing portion 50 can be included in the image signal processing portion 13 illustrated in FIG. 1. Alternatively, the image signal processing portion 13 and the CPU 23 may constitute the image processing portion 50. The image processing portion 50 includes individual portions denoted by numerals 51 to 53.

The image processing portion 50 is supplied with image data of an input image sequence. The image sequence such as the input image sequence means a series of a plurality of images arranged in time sequence. Therefore, the input image sequence is constituted of a plurality of input images arranged in time sequence. The image sequence can be read as a moving image. For instance, the input image sequence is a moving image including a plurality of input images arranged in time sequence as a plurality of frames. The input image is, for example, a photographed image expressed by the output signal itself of the AFE 12, or an image obtained by performing a predetermined image processing (such as a demosaicing process or a noise reduction process) on a photographed image expressed by the output signal itself of the AFE 12. An arbitrary image sequence recorded in the external memory 18 can be read out from the external memory 18 and supplied to the image processing portion 50 as the input image sequence. For instance, a manner in which a subject swings a golf club or a baseball bat is photographed as a moving image by the image pickup apparatus 1 and is recorded in the external memory 18. Then, the recorded moving image can be supplied as the input image sequence to the image processing portion 50. Note that the input image sequence can be supplied from an external arbitrary portion other than the external memory 18. For instance, the input image sequence may be supplied to the image processing portion 50 via communication from external equipment (not shown) of the image pickup apparatus 1.

A region setting portion 51 sets a clipping region as an image region in the input image based on image data of the input image sequence so as to generate and output clipping region information indicating a position and a size of the clipping region. A position of the clipping region indicated by the clipping region information is, for example, a center position or a barycenter position of the clipping region. A size of the clipping region indicated by the clipping region information is, for example, a size of the clipping region in the horizontal and the vertical directions. If the clipping region has a shape except a rectangle, the clipping region information contains information for specifying a shape of the clipping region.

A clipping process portion 52 extracts an image within the clipping region as the clipped image from the input image based on the clipping region information (in other words, an image within the clipping region is clipped as the clipped image from the input image). The clipped image is a part of the input image. Hereinafter, a process of generating the clipped image from the input image based on the clipping region information is referred to as a clipping process. The clipping process is performed on a plurality of input images, and hence a plurality of clipped images are obtained. Similarly to the plurality of input images, the plurality of clipped images are also arranged in time sequence. Therefore, the plurality of clipped images can be called a clipped image sequence.

An image combining portion 53 combines a plurality of clipped images and outputs the image obtained by combining as an output combined image. The output combined image can be displayed on the display screen of the display portion 27, and image data of the output combined image can be recorded in the external memory 18.

The image combining function can be realized in the reproduction mode. The reproduction mode for realizing the image combining function is split into a plurality of combining modes. When the user issues an instruction to select one of the plurality of combining modes to the image pickup apparatus 1, an action in the selected combining mode is performed. The user can issue an arbitrary instruction with the operating portion 26 to the image pickup apparatus 1. A so-called touch panel may be included in the operating portion 26. The plurality of combining modes may include a first combining mode that can also be called a multi-window combining mode. Hereinafter, the first embodiment describes an action of the image pickup apparatus 1 in the first combining mode.

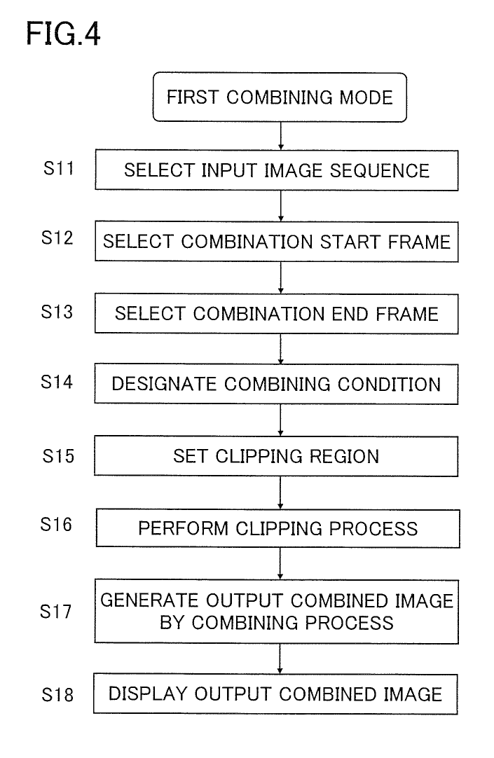

FIG. 4 is an action flowchart of the image pickup apparatus 1 in the first combining mode. In the first combining mode, the processes of Steps S11 to S18 are performed sequentially. In Step S11, the user selects the input image sequence. The user can select a desired moving image from the moving images recorded in the external memory 18, and the selected moving image is supplied to the image processing portion 50 as the input image sequence. Note that it is possible to perform the operation of selecting the first combining mode from the plurality of combining modes after selecting the moving image as the input image sequence.

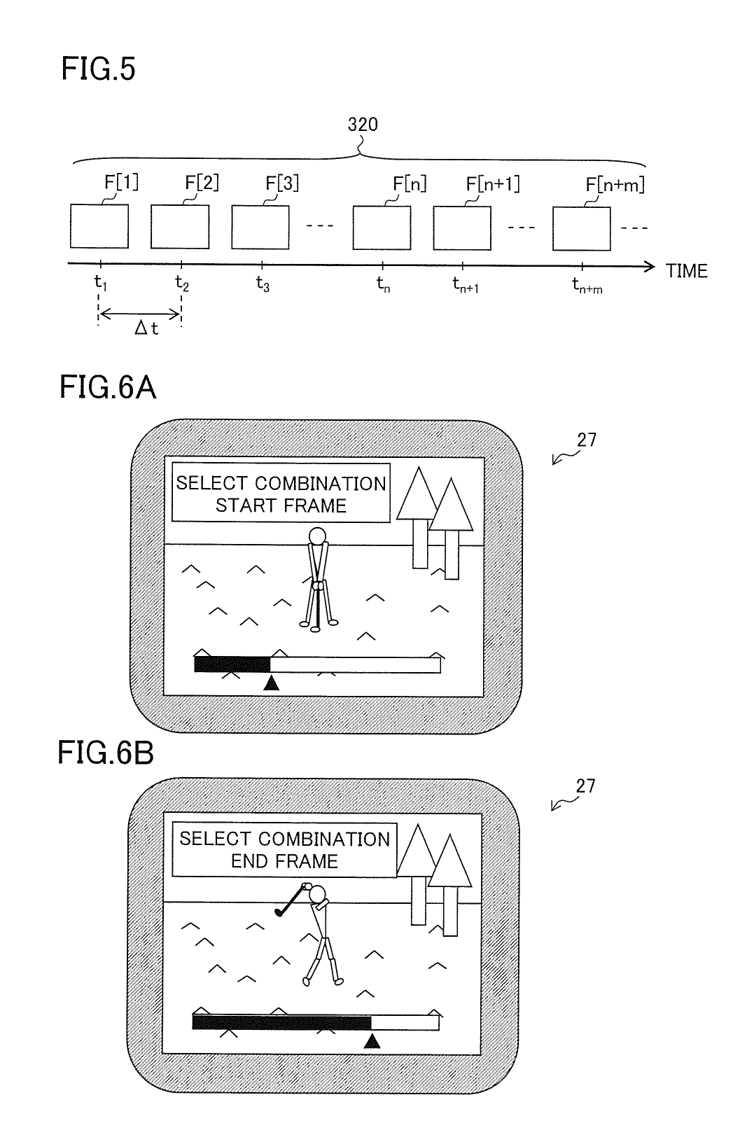

It is supposed that the input image sequence supplied to the image processing portion 50 is an input image sequence 320 illustrated in FIG. 5. An i-th frame of the input image sequence 320, namely an i-th input image of the input image sequence 320 is expressed by F[i]. The input image sequence 320 includes input images F[1], F[2], F[3], . . . , F[n], F[n+1], . . . , F[n+m], and so on. Letters i, n and m denote natural numbers. Time point tᵢ is a photographing time point of the input image F[i], and time point tᵢ₊₁ is a time point after the time point tᵢ. Therefore, the input image F[i+1] is an image photographed after the input image F[i]. A time difference Δt between the time points tᵢ and tᵢ₊₁ corresponds to a frame period of a moving image as the input image sequence 320. Although not clear from FIG. 5, it is supposed that the input image sequence 320 is a moving image obtained by photographing a subject swinging a golf club.

In Step S12, the user selects a combination start frame using the operating portion 26. When the combination start frame is selected, as illustrated in FIG. 6A for example, an input image desired by the user that is one of input images of the input image sequence 320 is displayed on the display portion 27 in accordance with a user's operation with the operating portion 26. Then, the display image at time point when the user performed a deciding operation may be selected as the combination start frame. In FIG. 6A, a part with hatching indicates a casing part of the display portion 27 (the same is true for FIG. 6B that will be referred to).

In the next Step S13, the user selects a combination end frame using the operating portion 26. When the combination end frame is selected, as illustrated in FIG. 6B for example, an input image desired by the user that is one of input images of the input image sequence 320 is displayed on the display portion 27 in accordance with a user's operation with the operating portion 26. Then, a display image at time point when the user performed the deciding operation may be selected as the combination end frame.

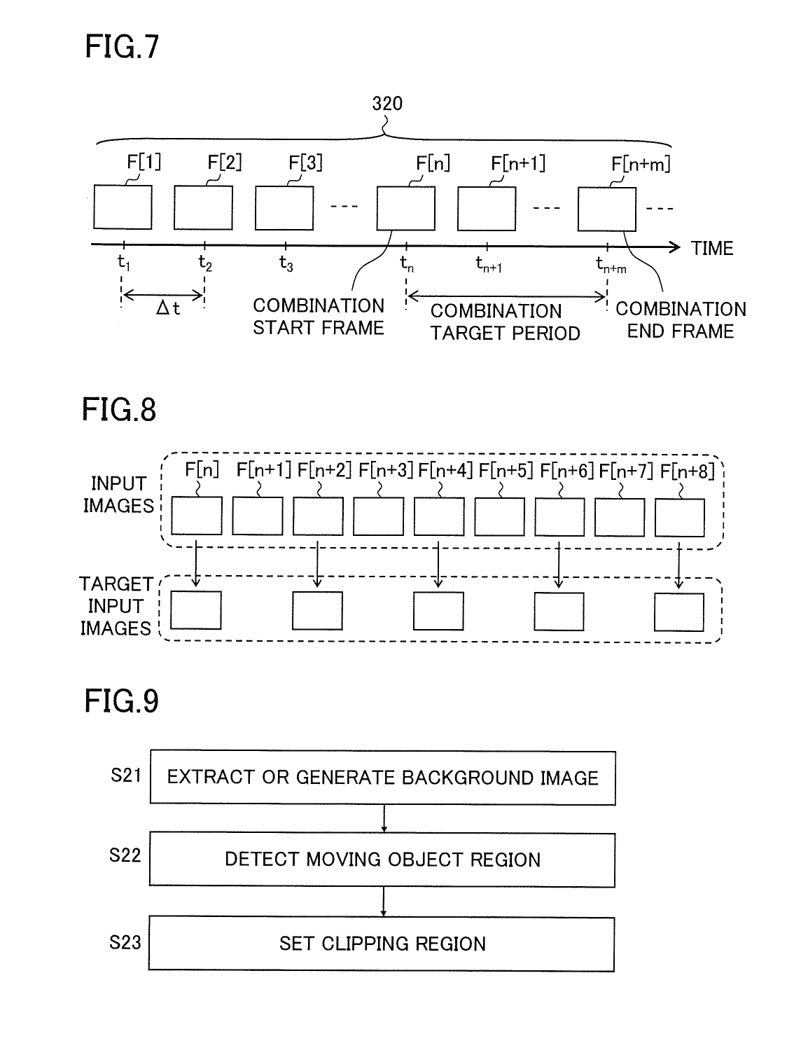

The combination start frame and the combination end frame are input images of the input image sequence 320, and the input image as the combination end frame is an input image photographed after the combination start frame. Here, as illustrated in FIG. 7, it is supposed that the input images F[n] and F[n+m] are selected as the combination start frame and the combination end frame, respectively. A period of time from time point tₙ that is a photographing time point of the combination start frame until time point tₙ₊ₘ that is a photographing time point of the combination end frame is referred to as a combination target period. For instance, the time point tₙ corresponding to the combination start frame is just before the subject starts to swing the golf club (see FIG. 6A), and the time point tₙ₊ₘ corresponding to the combination end frame is just after the subject finished to swing the golf club (see FIG. 6B). It is supposed that the time point tₙ and the time point tₙ₊ₘ are also included in the combination target period. Therefore, the input images belonging to the combination target period are the input images F[n] to F[n+m].

After selecting the combination start frame and the combination end frame, the user can designate a combining condition using the operating portion 26 in Step S14. For instance, the number of images to be combined for obtaining the output combined image (hereinafter, referred to as combining number C_{NUM}) or the like can be designated. The combining condition may be set in advance, and in this case, the designation in Step S14 may be omitted. Meaning of the combining condition will be apparent from later description. The process in Step S14 may be performed before Steps S12 and S13.

All the input images F[n] to F[n+m] belonging to the combination target period do not always contribute to formation of the output combined image. An input image that contributes to formation of the output combined image among the input images F[n] to F[n+m] is referred to particularly as a target input image. There are a plurality of target input images, and a first target input image is an input image F[n]. The user can designate a sampling interval that is one type of the combining condition in Step S14. However, the sampling interval may be set in advance. The sampling interval is a photographing time point interval between two target input images that are temporally neighboring to each other. For instance, if the sampling interval is Δt×i (see FIG. 5, too), the target input images are sampled from the input images F[n] to F[n+m] at a sampling interval of Δt×i with reference to the input image F[n] (i denotes an integer). More specifically, if m is eight and the sampling interval is Δt×2, for example, the input images F[n], F[n+2], F[n+4], F[n+6] and F[n+8] are extracted as the target input images as illustrated in FIG. 8. The value of m is determined by the processes of Steps S12 and S13. Therefore, when the sampling interval is determined, the combining number C_{NUM} is automatically determined.

After the value of m and the combining number C_{NUM} are determined, the sampling interval and the target input images may be set based on the determined value of m and combining number C_{NUM}. For instance, if m=8 and C_{Num}=5 are determined, the sampling interval is set to Δt×(m/(C_{Num}−1)), namely (Δt×2). As a result, the input images F[n], F[n+2], F[n+4], F[n+6] and F[n+8] are extracted as the target input images.

After the processes of Steps S12 to S14, the processes Steps S15 to S17 are performed sequentially. Specifically, the region setting portion 51 performs the clipping region setting process in Step S15, the clipping process portion 52 performs the clipping process in Step S16, and the image combining portion 53 performs the combining process in Step S17, so as to generate the output combined image (see FIG. 3, too). The output combined image generated in Step S17 is displayed on the display screen of the display portion 27 in Step S18. The image data of the output combined image may be also recorded in the external memory 18. The processes in Steps S15 to S17 are described below in detail.

[S15: Clipping Region Setting]

The clipping region setting process in Step S15 is described below. FIG. 9 is a flowchart of the clipping region setting process. The region setting portion 51 performs the processes of Steps S21 to S23 sequentially so that the clipping region can be set.

First in Step S21, the region setting portion 51 extracts or generates a background image. Input images that do not belong to the combination target period among input images of the input image sequence 320 are regarded as candidate background images, and one of the plurality of candidate background images can be extracted as the background image. The plurality of candidate background images include input images F[1] to F[n−1], and may further include input image F[n+m+1], F[n+m+2], and so on. The region setting portion 51 can select the background image from the plurality of candidate background images based on image data of the input image sequence 320. It is possible to adopt a structure in which the user manually selects the background image from the plurality of candidate background images.

It is preferred to select an input image having no moving object region as the background image. On a moving image consisting of a plurality of input images, an object that is moving is referred to as a moving object, and an image region in which image data of the moving object exists is referred to as a moving object region.

For instance, the region setting portion 51 is formed so that the region setting portion 51 can perform a movement detection processing. In the movement detection processing, based on image data of two input images that are temporally neighboring to each other, an optical flow between the two input images is derived. As known well, the optical flow between the two input images is a bundle of motion vectors of objects between the two input images. The motion vector of an object between two input images indicates a direction and a size of a motion of the object between the two input images.

A size of the motion vector corresponding to the moving object region is larger than that of a region other than the moving object region. Therefore, it is possible to estimate whether or not a moving object exists in the plurality of input images from the optical flow of the plurality of input images. Therefore, for example, the movement detection processing is performed on the input images F[1] to F[n−1], so as to derive the optical flow between input images F[1] and F[2], the optical flow between input images F[2] and F[3], . . . , and the optical flow between the input images F[n−2] and F[n−1]. Then, based on the derived optical flows, the input image that is estimated to have no moving object can be extracted from the input images F[1] to F[n−1]. The extracted input image (the input image that is estimated to have no moving object) can be selected as the background image.

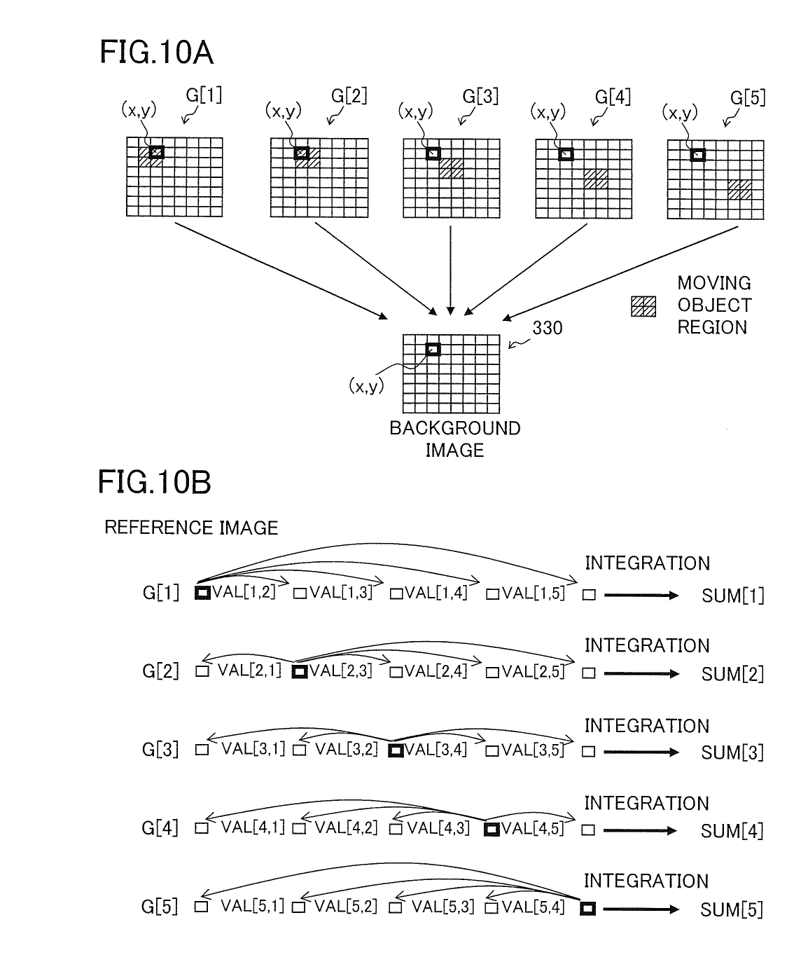

In addition, for example, it is possible to generate the background image by the background image generating process using the plurality of input images. A method of the background image generating process is described below with reference to FIGS. 10A and 10B. FIG. 10A indicates a plurality of input images G[1] to G[5] from which a background image is generated. An image 330 is the background image generated from the input images G[1] to G[5]. In each input image of FIG. 10A, each of regions with hatching express the moving object region. The input images G[1] to G[5] are five input images extracted from the input images of the input image sequence 320. If m is four, the plurality of input images G[1] to G[5] are, for example, the input images F[n] to F[n+m] (see FIG. 7). Alternatively, for example, if m is larger than four, the plurality of input images G[1] to G[5] are any five input images out of the input images F[n] to F[n+m]. Further alternatively, for example, any of the input images F[1] to F[n−1] or any of the input image F[n+m+1], F[n+m+2], and so on may be included in the input images G[1] to G[5]. Further alternatively, for example, it is possible to use only input images that do not belong to the combination target period so as to form the input images G[1] to G[5].

In the background image generating process, a background pixel extraction process is performed for each pixel position. The background pixel extraction process performed on a pixel position (x, y) is described below. In the background pixel extraction process, the region setting portion 51 first sets the input image G[1] to a reference image and sets each of the input images G[2] to G[5] to a non-reference image. Then, the region setting portion 51 performs a differential calculation for each non-reference image. Here, the differential calculation means a calculation of determining an absolute value of a difference between a pixel signal of the reference image at the pixel position (x, y) and a pixel signal of the non-reference image at the pixel position (x, y) as a difference factor value. The pixel signal means a signal of a pixel, and a value of the pixel signal is also referred to as a pixel value. As the pixel signal in the differential calculation, a luminance signal can be used, for example.

If the input image G[1] is the reference image, the differential calculation for each non-reference image derives,

a difference factor value VAL[1, 2] based on the pixel signal of the input image G[1] at the pixel position (x, y) and the pixel signal of the input image G[2] at the pixel position (x, y),

a difference factor value VAL[1, 3] based on the pixel signal of the input image G[1] at the pixel position (x, y) and the pixel signal of the input image G[3] at the pixel position (x, y),

a difference factor value VAL[1, 4] based on the pixel signal of the input image G[1] at the pixel position (x, y) and the pixel signal of the input image G[4] at the pixel position (x, y), and

a difference factor value VAL[1, 5] based on the pixel signal of the input image G[1] at the pixel position (x, y) and the pixel signal of the input image G[5] at the pixel position (x, y).

The region setting portion 51 performs the differential calculation for each non-reference image while switching the input image to be set to the reference image from the input image G[1] to the input images G[2], G[3], G[4], and G[5] sequentially (the input images other than the reference image are set to the non-reference images). Thus, a difference factor value VAL[i, j] based on the pixel signal of the input image G[i] at the pixel position (x, y) and the pixel signal of the input image G[j] at the pixel position (x, y) is determined for every combination of variables i and j satisfying 1≦i≦5 and 1≦j≦5 (here, i and j are different integers).

The region setting portion 51 determines a sum of four difference factor values VAL[i, j] determined in a state where the input image G[i] is set to the reference image, as a difference integrated value SUM[i]. The difference integrated value SUM[i] is derived for each of the input images G[1] to G[5]. Therefore, five difference integrated values SUM[1] to SUM[5] are determined for the pixel position (x, y). The region setting portion 51 specifies a minimum value within the difference integrated values SUM[1] to SUM[5], and sets a pixel and a pixel signal of the input image at the pixel position (x, y) corresponding to the minimum value as a pixel and a pixel signal of the background image 330 at the pixel position (x, y). In other words, for example, if the difference integrated value SUM[4] is minimum among the difference integrated values SUM[1] to SUM[5], a pixel and a pixel signal of the input image G[4] at the pixel position (x, y) corresponding to the difference integrated value SUM[4] are set to a pixel and a pixel signal of the background image 330 at the pixel position (x, y).

The moving object region of the example illustrated in FIG. 10A is positioned at the pixel position (x, y) in the input images G[1] and G[2] but is not positioned at the pixel position (x, y) in the input images G[3] to G[5]. Therefore, the difference integrated values SUM[1] and SUM[2] have relatively large values, while the difference integrated values SUM[3] to SUM[5] have relatively small values. Therefore, a pixel different from pixels within the moving object region (namely, a background pixel) is adopted as the pixel of the background image 330.

As described above, in the background image generating process, the background pixel extraction process is performed for each pixel position. Therefore, the same processes as described above are performed sequentially for pixel positions other than the pixel position (x, y), and finally the pixel signal is determined at every pixel position of the background image 330 (namely, generation of the background image 330 is completed). Note that according to the action described above, the difference factor value VAL[i, j] and the difference factor value VAL[j, i] are calculated individually, but the values thereof are the same. Therefore, it is actually sufficient if one of them is calculated. In addition, the background image is generated from five input images in the example illustrated in FIGS. 10A and 10B, but it is possible to generate the background image from two or more arbitrary numbers of input images.

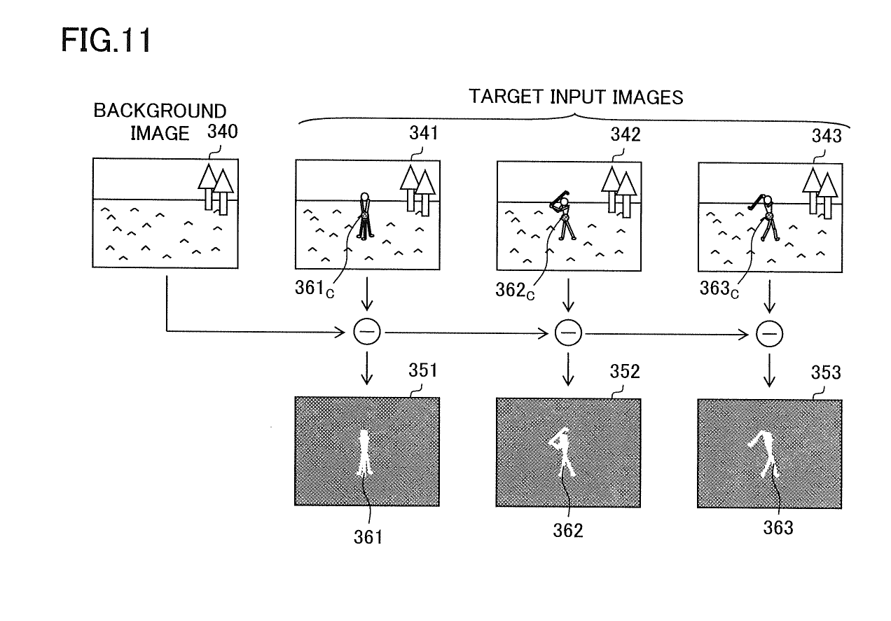

In Step S22 (see FIG. 9), the region setting portion 51 illustrated in FIG. 3 detects the moving object region based on image data of the background image and the individual target input images. In FIG. 11, an image 340 is an example of the background image, and images 341 to 343 are examples of the target input images. For specific description, it is supposed that the background image is the image 340 and that the plurality of target input images extracted from the input images F[n] to F[n+m] are the images 341 to 343. Then, a detection method of a moving object region and a process of Step S23 are described below.

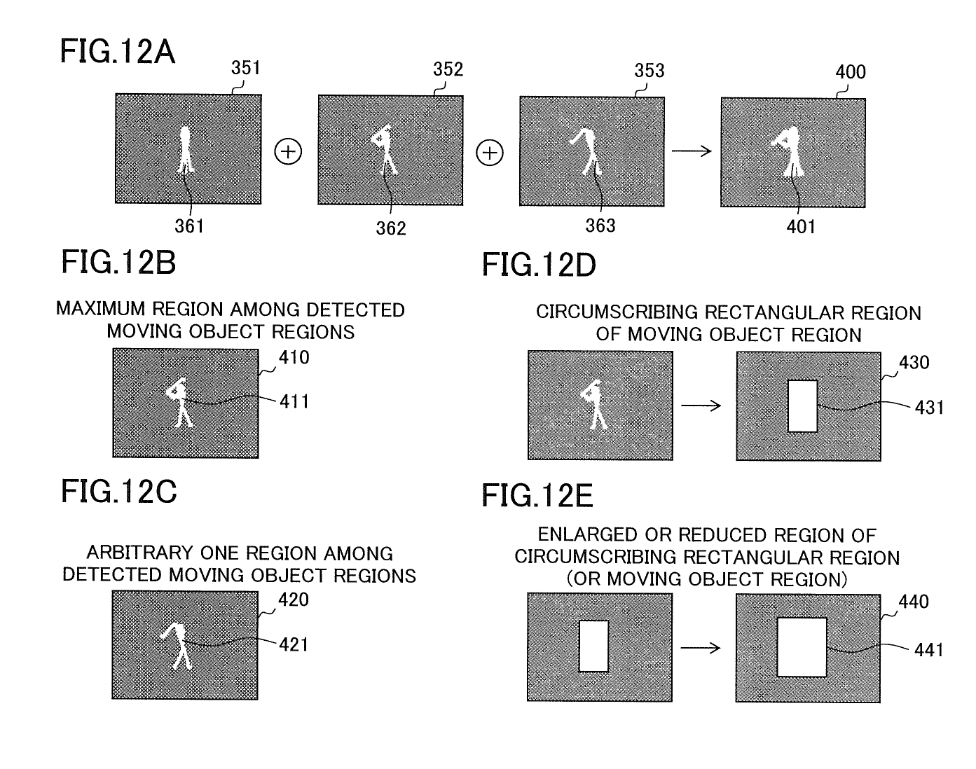

The region setting portion 51 generates a difference image between the background image and the target input image for each target input image, and performs thresholding (i.e., binarization) on the generated difference image so as to generate a binary difference image. In FIG. 11, an image 351 is a binary difference image based on the background image 340 and the target input image 341, an image 352 is a binary difference image based on the background image 340 and the target input image 342, and an image 353 is a binary difference image based on the background image 340 and the target input image 343. The difference image between the first and the second images means an image having a pixel signal that is a pixel signal difference of between the first and the second images. For instance, a pixel value at the pixel position (x, y) of the difference image between the first and the second images is an absolute value of a difference between a luminance value of the first image at the pixel position (x, y) and a luminance value of the second image at the pixel position (x, y). In the difference image between the background image 340 and the target input image 341, a pixel value “1” is given to pixels having pixel values of a predetermined threshold value or larger while a pixel value “0” is given to pixels having pixel values smaller than the threshold value. As a result, a binary difference image 351 having only pixel values of “1” or “0” can be obtained. The same process is performed for the binary difference images 352 and 353. In the diagram including FIG. 11, in which the binary difference image is illustrated, an image region having a pixel value “1” (namely an image region having a large difference) is expressed by white, and an image region having a pixel value “0” (namely an image region having a small difference) is expressed by black. In the binary difference image 351, an image region having a pixel value “1” is detected as a moving object region 361. In the same manner, in the binary difference image 352, an image region having a pixel value “1” is detected as a moving object region 362. In the binary difference image 353, an image region having a pixel value “1” is detected as a moving object region 363. In the binary difference image, a white region corresponds to the moving object region (the same is true in FIG. 12A and the like referred to later).

The moving object regions 361 to 363 are illustrated on the binary difference image 351 to 353 in FIG. 11, but the moving object regions 361 to 363 may be considered to be moving object regions in the target input images 341 to 343, respectively. In FIG. 11, points 361_{C}, 362_{C} and 363_{C} respectively indicate a center position or a barycenter position of the moving object region 361 in the target input image 341, a center position or a barycenter position of the moving object region 362 in the target input image 342, and a center position or a barycenter position of the moving object region 363 in the target input image 343.

After that, in Step S23 (see FIG. 9), the region setting portion 51 illustrated in FIG. 3 sets the clipping region based on the moving object region detected in Step S22. With reference to FIGS. 12A to 12E, a method of setting the clipping region from the moving object regions 361 to 363 is described below.

As illustrated in FIG. 12A, the region setting portion 51 can determine a region (white region) 401 that is a logical OR region of the moving object regions 361 to 363. In FIG. 12A, an image 400 is a binary image obtained by a logical OR operation of the image 351 to 353. In other words, a pixel value of the binary image 400 at the pixel position (x, y) is a logical OR of a pixel value of the image 351 at the pixel position (x, y), a pixel value of the image 352 at the pixel position (x, y), and a pixel value of the image 353 at the pixel position (x, y). In the binary image 400, an image region having a pixel value “1” is the region 401.

As illustrated in FIG. 12B, the region setting portion 51 can determine a moving object region having a largest size among the moving object regions 361 to 363 as a region (white region) 411. An binary image 410 illustrated in FIG. 12B is the image 351 when the region 411 is the moving object region 361, is the image 352 when the region 411 is the moving object region 362, and is the image 353 when the region 411 is the moving object region 363.

As illustrated in FIG. 12C, the region setting portion 51 can set an arbitrary region among the moving object regions 361 to 363 as a region (white region) 421. A binary image 420 illustrated in FIG. 12C is the image 351 when the region 421 is the moving object region 361, is the image 352 when the region 421 is the moving object region 362, and is the image 353 when the region 421 is the moving object region 363.

As illustrated in FIG. 12D, the region setting portion 51 can set a rectangular region circumscribing one of the moving object regions as a region (white region) 431. A rectangular region circumscribing the region 401 illustrated in FIG. 12A may be set as the region 431. In other words, the region 431 is a smallest rectangular image region that can include the region 401, 411 or 421. An image 430 illustrated in FIG. 12D is a binary image having only a pixel value “1” in the region 431 and only a pixel value “0” in other image region.

A region (white region) 441 illustrated in FIG. 12E is an image region obtained by enlarging or reducing the rectangular region 431 by a predetermined ratio. Alternatively, the region 441 may be an image region obtained by enlarging or reducing the region 401, 411 or 421 by a predetermined ratio. The enlarging or reducing operation for generating the region 441 can be performed in each of the horizontal and vertical directions. An image 440 illustrated in FIG. 12E is a binary image having only a pixel value “1” in the region 441 and only a pixel value “0” in other image region.

In Step S23 (see FIG. 9), the region setting portion 51 can set the region 401, 411, 421, 431 or 441 as the clipping region.

The background image is used for setting the clipping region in the method according to Steps S21 to S23 of FIG. 9, but it is possible to set the clipping region without using the background image. Specifically, for example, an optical flow between the input images F[i] and F[i+1] is derived by the movement detection processing based on image data of the input image sequence 320. The optical flow to be derived includes at least an optical flow based on the input images in the combination target period, and an optical flow based on the input images outside the combination target period (for example, an optical flow between the input images F[n−2] and F[n−1]) is also derived as necessary. Then, based on the derived optical flow, the moving object region may be detected from each of the input images F[n] to F[n+m]. The detection method of the moving object and the moving object region based on the optical flow is known. The action after detecting the moving object region is as described above.

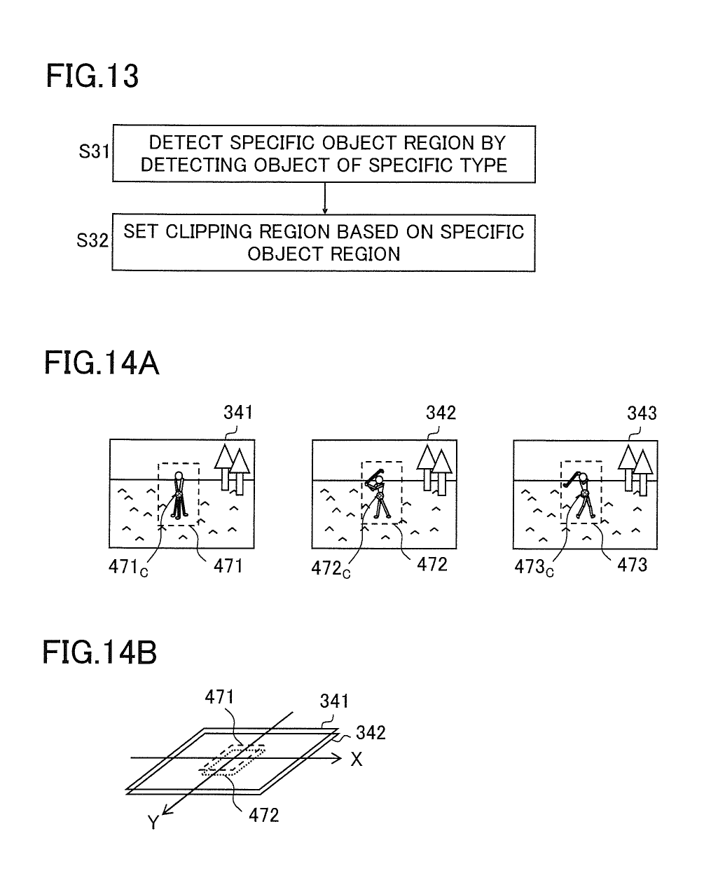

Alternatively, for example, it is possible to set the clipping region by performing the processes of Steps S31 and S32 of FIG. 13 instead of the processes of Steps S21 to S23 of FIG. 9. FIG. 13 corresponds to a variation flowchart of the clipping region setting process.

In Step S31, the region setting portion 51 detects an image region where an object of specific type exits from the target input image as a specific object region (or a specific subject region) based on the image data of the target input image. The detection of the specific object region can be performed for each target input image. The object of specific type means an object of a type that is registered in advance, which is an arbitrary person or a registered person, for example. If the object of specific type is a registered person, it is possible to detect the specific object region by a face recognition process based on the image data of the target input image. In the face recognition process, if there is a person's face in the target input image, it is possible to distinguish whether or not the face is a registered person's face. As the detection method of the specific object region, an arbitrary detection method including a known detection method can be used. For instance, the specific object region can be detected by using a face detection process for detecting a person's face from the target input image, and a region splitting process for distinguishing the image region where image data of the whole body of the person exist from other image region while utilizing a result of the face detection process.

In Step S32, the region setting portion 51 sets the clipping region based on the specific object region detected in Step S31. The setting method of the clipping region based on the specific object region is the same as the setting method of the clipping region based on the moving object region described above. In other words, for example, if the plurality of target input images extracted from the input images F[n] to F[n+m] are the images 341 to 343 illustrated in FIG. 11, when the regions 361 to 363 are detected as the specific object regions from the target input images 341 to 343, the region setting portion 51 can set the region 401, 411, 421, 431 or 441 illustrated in FIG. 12A or the like as the clipping region.

Note that the object of specific type that is noted when the combining mode is used is usually a moving object, and therefore, the specific object region can be regarded as the moving object region. Hereinafter, for convenience sake of description, the specific object region is also regarded as one type of the moving object region, and it is supposed that the specific object regions detected from the target input images 341 to 343 are agreed with the moving object regions 361 to 363, respectively. In addition, in the following description, it is supposed that the clipping region is a rectangular region unless otherwise noted.

[S16: Clipping Process]

The clipping process in Step S16 of FIG. 4 is described below. In the clipping process, the clipping region determined as described above is set to each target input image, and an image in the clipping region of each target input image is extracted as the clipped image.

A position, a size and a shape of the clipping region in the target input image are the same among all the target input images. However, a position of the clipping region in the target input image may be different among different target input images. The position of the clipping region in the target input image means a center position or a barycenter position of the clipping region in the target input image. The size of the clipping region means a size of the clipping region in the horizontal and vertical directions.

It is supposed that the plurality of target input images extracted from the input images F[n] to F[n+m] includes the images 341 to 343 illustrated in FIG. 11, and that the target input image 341 is the combination start frame. Then, the clipping process of Step S16 is described below more specifically. Under this supposition, the clipping process portion 52 sets clipping regions 471, 472 and 473 to the target input images 341, 342 and 343, respectively, as illustrated in FIG. 14A. Then, the clipping process portion 52 extracts an image in the clipping region 471, an image in the clipping region 472, and an image in the clipping region 473 as three clipped images. Because the clipping regions 471 to 473 are the same clipping region, a size and a shape of the clipping region 471 in the target input image 341, a size and a shape of the clipping region 472 in the target input image 342, and a size and a shape of the clipping region 473 in the target input image 343 are the same.

In FIG. 14A, points 471_{C}, 472_{C}, and 473_{C} respectively indicate a center position or a barycenter position of the clipping region 471 in the target input image 341, a center position or a barycenter position of the clipping region 472 in the target input image 342, and a center position or a barycenter position of the clipping region 473 in the target input image 343. The position 471 is agreed with a center position or a barycenter position of the moving object region 361 in the target input image 341, namely the position 361_{C} illustrated in FIG. 11. Further, basically, the positions 472_{C} and 473_{C} are the same as the position 471. Therefore, as illustrated in FIG. 14B, when the target input images 341 and 342 are disposed in the same image space XY so that the pixel position (x, y) in the target input image 341 and the pixel position (x, y) in the target input image 342 are agreed with each other, the clipping regions 471 and 472 are agreed completely with each other. The same is true for the clipping regions 471 and 473.

However, the positions 472_{C} and 473_{C} illustrated in FIG. 14A may be agreed with the positions 362_{C} and 363_{C} illustrated in FIG. 11, respectively. In this case, the positions 471_{C}, 472_{C} and 473_{C} can be different from each other.

[S17: Combining Process]

The combining process in Step S17 of FIG. 4 is described below. In the combining process, a plurality of clipped images are arranged in the horizontal or vertical direction so that the plurality of clipped images are not overlapped with each other, and they are combined. The image obtained by this combining process is generated as the output combined image. The number of clipped images arranged in the horizontal direction (namely, the X-axis direction in FIG. 2) and the number of clipped images arranged in the vertical direction (namely, the Y-axis direction in FIG. 2) are denoted by H_{NUM} and V_{NUM}, respectively. The above-mentioned combining number C_{NUM} that is agreed with the number of clipped images is a product of H_{NUM} and V_{NUM}.

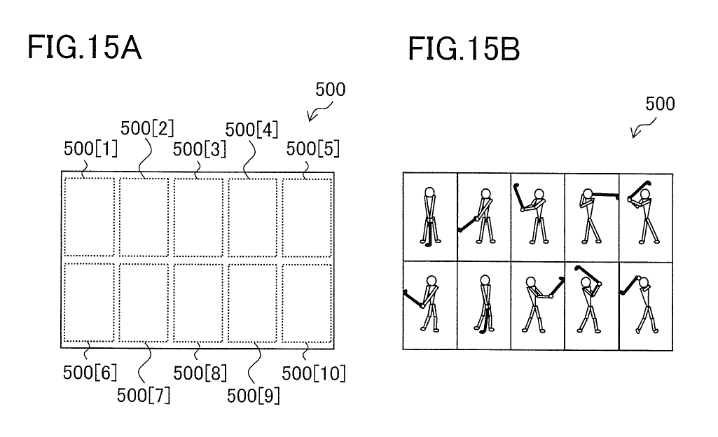

An image 500 illustrated in FIG. 15A is an example of the output combined image when C_{NUM}=10, H_{NUM}=5, and V_{NUM}=2 hold. FIG. 15B illustrates a specific example of the output combined image 500. When the output combined image 500 is generated, first to tenth clipped images are generated from first to tenth target input images. An i-th clipped image is extracted from an i-th target input image. A photographing time point of an (i+1)th target input image is later than that of the i-th target input image. In the output combined image 500, image regions 500[1] to 500[5] are arranged in this order continuously from the left to the right, and image region 500[6] to 500[10] are also arranged in this order continuously from the left to the right (see FIG. 2 for the definition of left and right). When i is 1, 2, 3, 4 or 5, the image regions 500[i] and 500[i+5] are adjacent to each other in the vertical direction. When i and j are different integers, image regions 500[i] and 500[j] are not overlapped with each other. In the image regions 500[1] to 500[10] of the output combined image 500, the first to tenth clipped images are disposed, respectively. Therefore, the output combined image 500 is a combination result image in which the first to tenth clipped images are arranged in the horizontal or vertical direction and are combined.

The arrangement of the clipped images on the output combined image as illustrated in FIG. 15A is an example, and the image combining portion 53 illustrated in FIG. 3 can determine the arrangement of the clipped images in accordance with the combining number C_{NUM}, an aspect ratio of the output combined image, the image size of the same, or the like. In the image pickup apparatus 1, an aspect ratio or an image size of the output combined image can be set in advance.

A method of determining the arrangement of the clipped images in accordance with an aspect ratio of the output combined image (namely a method of determining the arrangement of the clipped images in the state where the aspect ratio of the output combined image is fixed) is described below. The aspect ratio of the output combined image means a ratio between the number of pixels in the horizontal direction of the output combined image and the number of pixels in the vertical direction of the output combined image. Here, it is supposed that the aspect ratio of the output combined image is 4:3. In other words, it is supposed that the number of pixels in the horizontal direction of the output combined image is 4/3 times the number of pixels in the vertical direction of the output combined image. In addition, the numbers of pixels in the horizontal and the vertical directions of the clipping region set in Step S15 of FIG. 4 are denoted by H_{CUTSIZE} and V_{CUTSIZE}, respectively. Then, the image combining portion 53 can determine the numbers H_{NUM} and V_{NUM} in accordance with the following expression (1).

(H_{NUM}×H_{CUTSIZE}):(V_{NUM}×V_{CUTSIZE})=4:3 (1)

For instance, if (H_{CUTSIZE}:V_{CUTSIZE})=(128:240), H_{NUM}:V_{NUM}=5:2 holds in accordance with the expression (1). In this case, if C_{NUM}=H_{NUM}×V_{NUM}=10 holds, H_{NUM}=5 and V_{NUM}=2 hold, and hence the output combined image 500 illustrated in FIG. 15A is generated. If C_{NUM}=H_{NUM}×V_{NUM}=40 holds, H_{NUM}=10 and V_{NUM}=4 hold, and hence the clipped images are arranged by 10 in the horizontal direction and by 4 in the vertical direction so that the output combined image is generated. When the arrangement of the clipped images is determined in accordance with the aspect ratio of the output combined image, the image size of the output combined image can change variously.

A method of determining the arrangement of the clipped images in accordance with an image size of the output combined image (namely, a method of determining the arrangement of the clipped images in a state where the image size of the output combined image is fixed) is described below. The image size of the output combined image is expressed by the number of pixels H_{OSIZE} in the horizontal direction of the output combined image and the number of pixels V_{OSIZE} in the vertical direction of the output combined image. The image combining portion 53 can determine the numbers H_{NUM} and V_{NUM} in accordance with the following expressions (2) and (3).

H_{NUM}=H_{OSIZE}/H_{CUTSIZE} (2)

V_{NUM}=V_{OSIZE}/V_{CUTSIZE} (3)

For instance, if C_{NUM}=H_{NUM}×V_{NUM}=10, (H_{OSIZE}, V_{OSIZE})=(640, 480), and (H_{CUTSIZE}, V_{CUTSIZE})=(128, 240) hold, H_{NUM}=5 and V_{NUM}=2 are satisfied, because H_{OSIZE}/H_{CUTSIZE}=640/128=5, and V_{OSIZE}/V_{CUTSIZE}=480/240=2 hold. Therefore, the output combined image 500 illustrated in FIG. 15A is generated.

If the right sides of the expressions (2) and (3) become real numbers except integers, an integer value H_{INT} obtained by rounding off the right side of the expression (2) and an integer value V_{INT} obtained by rounding off the right side of the expression (3) are substituted into H_{NUM} and V_{NUM}, respectively. Then, the clipping region may be set again so that “H_{INT}=H_{OSIZE}/H_{CUTSIZE}” and “V_{INT}=V_{OSIZE}/V_{CUTSIZE}” are satisfied (namely, the clipping region that is once set is enlarged or reduced). For instance, if C_{NUM}=H_{NUM}×V_{NUM}=10, and (H_{OSIZE}, V_{OSIZE})=(640, 480) are satisfied, and if (H_{CUTSIZE}, V_{CUTSIZE})=(130, 235) is satisfied for the clipping region that is once set, the right sides of the expressions (2) and (3) are approximately 4.92 and approximately 2.04, respectively. In this case, H_{INT}=5 is substituted into H_{NUM}, and V_{INT}=2 is substituted into V_{NUM}. Then, the clipping region is set again so that “H_{INT}=H_{OSIZE}/H_{CUTSIZE}” and “V_{INT}=V_{OSIZE}/V_{CUTSIZE}” are satisfied. As a result, the number of pixels of the clipping region set again in the horizontal and the vertical directions are 128 and 240, respectively. If the clipping region is set again, the clipped image is generated by using the clipping region set again so that the output combined image is generated.

Note that in the flowchart illustrated in FIG. 4, the clipping region setting process and the clipping process are performed in Steps S15 and S16, and afterward the combining process including determining process of the arrangement of the clipped images is performed in Step S17. However, it is possible to perform the actual clipping process after performing the determining process of the arrangement of the clipped images considering that the clipping region can be set again. In addition, each of the values of H_{NUM} and V_{NUM} is one type of the combining condition, and it is possible to set values of H_{NUM} and V_{NUM} in accordance with a user's designation (see Step S14 in FIG. 4).

[Increasing and Decreasing of Combining Number]

A user can instruct to change the combining number C_{NUM} set once by the user or the combining number C_{NUM} set automatically by the image pickup apparatus 1. The user can issue an instruction to change the combining number C_{NUM} at an arbitrary timing. For instance, after the output combined image in a state of C_{NUM}=10 is generated and displayed, if the user wants to generate and display the output combined image in a state of C_{NUM}=20, the user can instruct to increase the combining number C_{NUM} from 10 to 20 by a predetermined operation with the operating portion 26. On the contrary, the user can also instruct to decrease the combining number C_{NUM}.

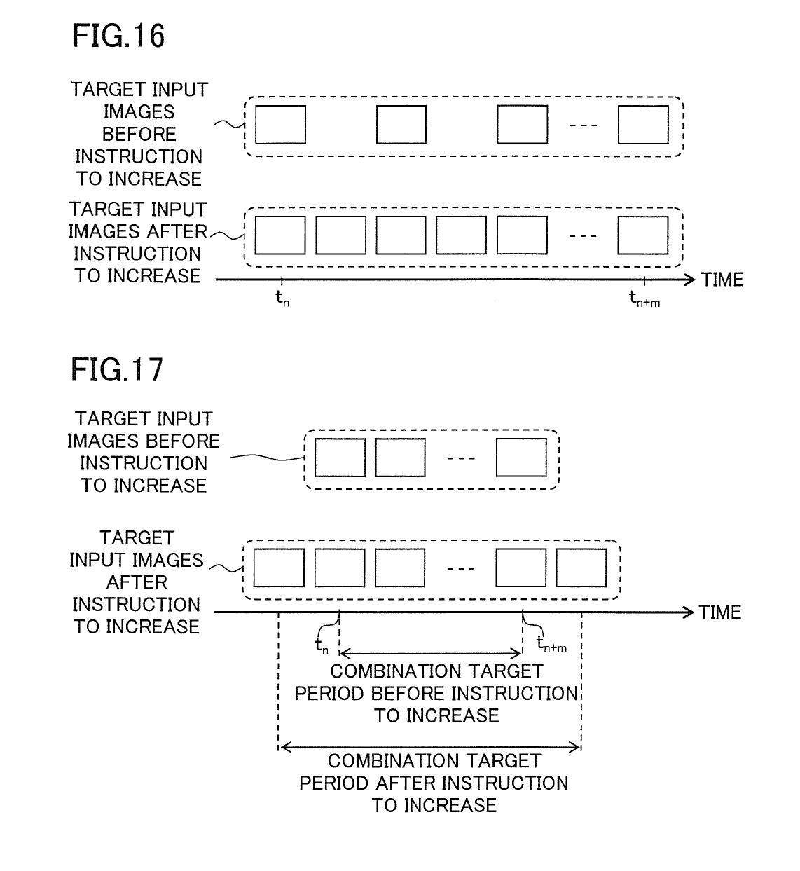

A first increasing or decreasing method of the combining number C_{NUM} is described below. FIG. 16 is a process image diagram of the first increasing or decreasing method when the instruction to increase or decrease the combining number C_{NUM} is issued. In the state where the combination target period is a period from the time point tₙ to the time point tₙ₊ₘ as illustrated in FIG. 7, if the user instructs to increase the combining number C_{NUM}, the image processing portion 50 according to the first increasing or decreasing method decreases the sampling interval with respect to the sampling interval before the increasing instruction is issued while maintaining the combination target period to be the period from the time point tₙ to the time point tₙ₊ₘ. Thus, the image processing portion 50 increases the number of target input images (namely combining number C_{NUM}). On the contrary, in the state where the combination target period is a period from the time point tₙ to the time point tₙ₊ₘ as illustrated in FIG. 7, if the user instructs to decrease the combining number C_{NUM}, the image processing portion 50 according to the first increasing or decreasing method increases the sampling interval with respect to the sampling interval before the decreasing instruction is issued while maintaining the combination target period to be the period from the time point tₙ to the time point tₙ₊ₘ. Thus, the image processing portion 50 decreases the number of target input images (namely combining number C_{NUM}). The specific numeric value of the sampling interval after the increasing instruction or after the decreasing instruction is determined based on the combining number C_{NUM} after the increasing instruction or after the decreasing instruction designated by the user.

A second increasing or decreasing method of the combining number C_{NUM} is described below. FIG. 17 is a process image diagram of the second increasing or decreasing method when increase of the combining number C_{NUM} is instructed. In the state where the combination target period is a period from the time point tₙ to the time point tₙ₊ₘ as illustrated in FIG. 7, if the user instructs to increase the combining number C_{NUM}, the image processing portion 50 according to the second increasing or decreasing method increases the combination target period by correcting a start time point of the combination target period to be earlier than the time point tₙ or by correcting an end time point of the combination target period to be later than the time point tₙ₊ₘ or by performing the both correction. Thus, the image processing portion 50 increases the number of target input images (namely combining number C_{NUM}). On the contrary, in the state where the combination target period is a period from the time point tₙ to the time point tₙ₊ₘ as illustrated in FIG. 7, if the user instructs to decrease the combining number C_{NUM}, the image processing portion 50 according to the second increasing or decreasing method decreases the combination target period by correcting the start time point of the combination target period to be later than the time point tₙ or by correcting the end time point of the combination target period to be earlier than the time point tₙ₊ₘ or by performing the both correction. Thus, the image processing portion 50 decreases the number of target input images (namely combining number C_{NUM}). Correction amounts of the start time point and the end time point of the combination target period are determined based on the combining number C_{NUM} after the increasing instruction or after the decreasing instruction designated by the user.

The sampling interval is not changed in the second increasing or decreasing method. However, it is possible to combine the first and the second increasing or decreasing methods. In other words, for example, when the user instructs to increase the combining number C_{NUM}, the decreasing of the sampling interval according to the first increasing or decreasing method and the increasing of the combination target period according to the second increasing or decreasing method may be performed simultaneously. Alternatively, when the user instructs to decrease the combining number C_{NUM}, it is possible to perform simultaneously the increasing of the sampling interval according to the first increasing or decreasing method and the decreasing of the combination target period according to the second increasing or decreasing method.

As described above, in this embodiment, the clipped images of the moving object are arranged in the horizontal or the vertical direction and are combined so that the output combined image is generated. Therefore, even if the position of the moving object is scarcely changed on the moving image in such a case where the moving object is a person who swings a golf club, moving objects at different time points are not overlapped with each other on the output combined image. As a result, a movement of the moving object can be checked more easily than the stroboscopic image as illustrated in FIG. 26. In addition, because the output combined image is generated not by using the frame itself of the moving image but by using the clipped image of the moving object part, the moving object can be displayed relatively largely on the output combined image. As a result, it is easier to check a movement of the moving object than the method as illustrated in FIG. 27.

### Second Embodiment

A second embodiment of the present invention is described below. The second embodiment and a third embodiment described later are embodiments on the basis of the first embodiment. The description of the first embodiment is applied also to the second and the third embodiments unless otherwise noted in the second and the third embodiments, as long as no contradiction arises. The plurality of combining modes described above in the first embodiment can include a second combining mode that is also referred to as a synchronized combining mode. Hereinafter, an action of the image pickup apparatus 1 in the second combining mode is described in the second embodiment.

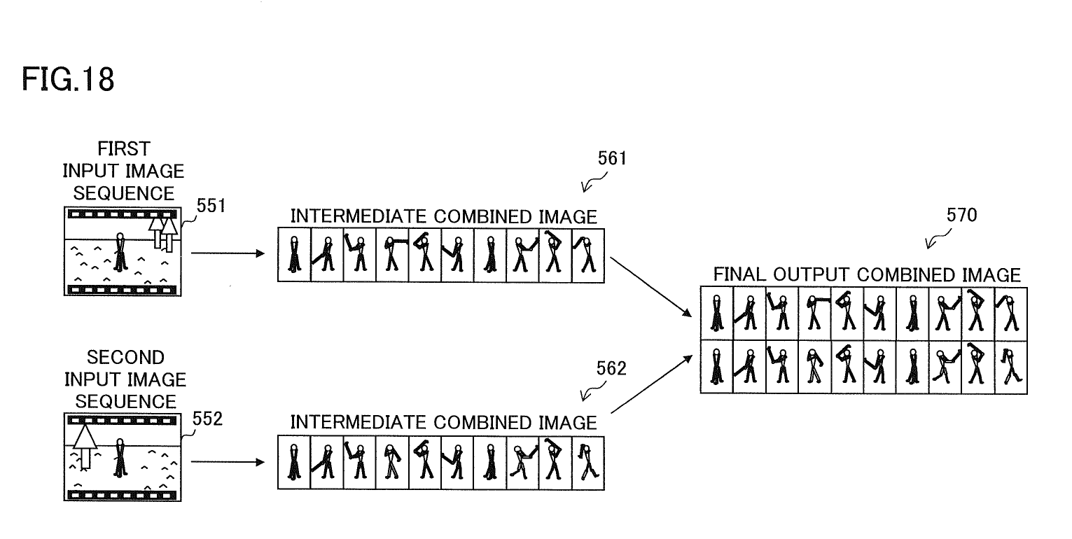

In the second combining mode, a plurality of input image sequences are used for generating output combined image. Here, for specific description, a method of using two input image sequences is described below. FIG. 18 illustrates a process flow when the output combined image is generated in the second combining mode. The user can select arbitrary two moving images from moving images recorded in the external memory 18, and the selected two moving images are supplied to the image processing portion 50 as first and second input image sequences 551 and 552. Usually, the input image sequences 551 and 552 are different from each other.

In the image processing portion 50, processes of Steps S12 to S17 illustrated in FIG. 4 are performed individually on the input image sequences 551 and 552. The processes of Steps S12 to S17 performed on the input image sequence 551 are the same as those described above in the first embodiment, and the processes of Steps S12 to S17 performed on the input image sequence 552 are also the same as those described above in the first embodiment. The output combined image generated by the processes of Steps S12 to S17 performed on the input image sequence 551 is referred to as an intermediate combined image (combination result image) 561. The output combined image generated by the processes of Steps S12 to S17 performed on the input image sequence 552 is referred to as an intermediate combined image (combination result image) 562.

In each of the intermediate combined images 561 and 562, H_{NUM} (the number of clipped images arranged in the horizontal direction) is two or larger, and V_{NUM} (the number of clipped images arranged in the vertical direction) is one. In other words, the intermediate combined image 561 is generated by arranging the plurality of clipped images based on the input image sequence 551 in the horizontal direction and combining them. The intermediate combined image 562 is generated by arranging the plurality of clipped images based on the input image sequence 552 in the horizontal direction and combining them. Basically, the sampling interval and the combining number C_{NUM} are the same between the input image sequences 551 and 552, but they may be different between the input image sequences 551 and 552. In the example illustrated in FIG. 18, in each of the intermediate combined images 561 and 562, H_{NUM}=10 and V_{NUM}=1 are set. Note that it is preferred that a size of the clipping region set in each input image is the same between the input image sequences 551 and 552. If a size of the clipping region is different between the input image sequences 551 and 552, an image size of the clipped image based on the input image sequence 551 can be agreed with an image size of the clipped image based on the input image sequence 552 by performing resolution conversion when the clipped image is generated from image data within the clipping region.

The image combining portion 53 illustrated in FIG. 3 generates a final output combined image 570 by arranging the intermediate combined images (combination result images) 561 and 562 in the vertical direction and combining them. The entire image region of the output combined image 570 is divided into two along the horizontal direction so that first and second image regions are set, and the intermediate combined images 561 and 562 are respectively disposed in the first and the second image regions of the output combined image 570. Note that it is possible to generate the output combined image 570 directly from the plurality of clipped images based on the input image sequences 551 and 552 without generating the intermediate combined images 561 and 562.

The output combined image 570 can be displayed on the display screen of the display portion 27, and thus a viewer of the display screen can easily compare a movement of the moving object on the input image sequence 551 with a movement of the moving object on the input image sequence 552. For instance, it is possible to compare a golf swing form in detail between the moving objects on the former and the latter.

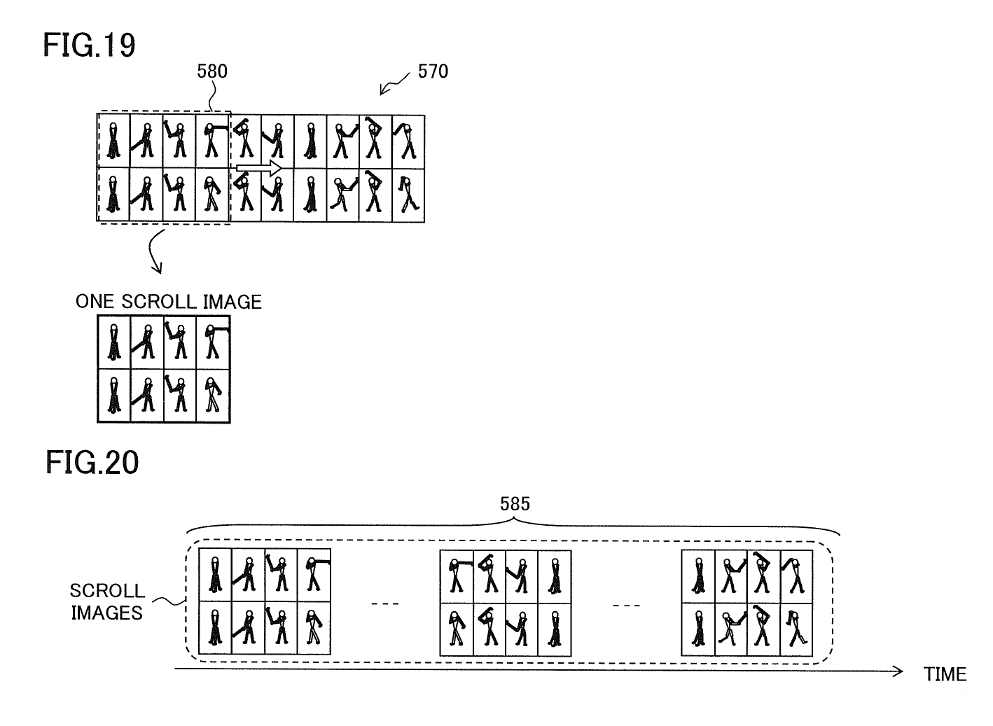

When the output combined image 570 is displayed, it is possible to use the resolution conversion as necessary so as to display the entire output combined image 570 at one time. It is also possible to perform the following scroll display. For instance, the display processing portion 20 illustrated in FIG. 1 performs the scroll display. In the scroll display, as illustrated in FIG. 19, an extraction frame 580 is set in the output combined image 570, and the image within the extraction frame 580 is extracted as a scroll image from the output combined image 570. Because the extraction frame 580 is smaller than the output combined image 570 in the horizontal direction, the scroll image is a part of the output combined image 570. A size of the extraction frame 580 in the vertical direction can be set to be the same as that of the output combined image 570.

A state where the left end of the extraction frame 580 is agreed with the left end of the output combined image 570 is set as a start point. Then, a position of the extraction frame 580 is moved sequentially at a constant interval until the right end of the extraction frame 580 is agreed with the right end of the output combined image 570, and the scroll image is extracted every time of the movement. In the scroll display, a plurality of scroll images obtained by this are arranged in time sequence order and displayed as a moving image 585 on the display portion 27 (see FIG. 20). Although depending on the number of clipped images, a display size of the moving object may be too small to display the entire output combined image 570. By using the above-mentioned scroll display, it is possible to avoid that a display size of the moving object becomes too small even if the number of clipped images is large. In addition, the image pickup apparatus 1 can record a plurality of scroll images arranged in time sequence in the external memory 18 as the moving image 585.

Note that in the above-mentioned example, the intermediate combined image based on the input image sequence 551 and the intermediate combined image based on the input image sequence 552 are arranged in the vertical direction and are combined. However, the intermediate combined image based on the input image sequence 551 and the intermediate combined image based on the input image sequence 552 may be arranged in the horizontal direction and combined. In this case, it is preferred to arrange in the horizontal direction the intermediate combined image obtained by arranging and combining the plurality of clipped images based on the input image sequence 551 in the vertical direction and the intermediate combined image obtained by arranging and combining the plurality of clipped images based on the input image sequence 552 in the vertical direction, and to combine them so that a final output combined image is obtained by the combining.

In addition, it is possible to use three or more input image sequences to obtain the output combined image. In other words, the three or more input image sequences may be supplied to the image processing portion 50, and the intermediate combined images respectively obtained from the input image sequences may be arranged in the horizontal or the vertical direction and combined so that the final output combined image is obtained.

### Third Embodiment

A third embodiment of the present invention is described below. When the input image in the above-mentioned first or second embodiment is obtained by photographing, so-called optical vibration correction or electronic vibration correction may be performed in the image pickup apparatus 1. In the third embodiment, when the input image is obtained by photographing, it is supposed that the electronic vibration correction is performed in the image pickup apparatus 1. Then, a method of setting the clipping region in conjunction with the electronic vibration correction is described below.

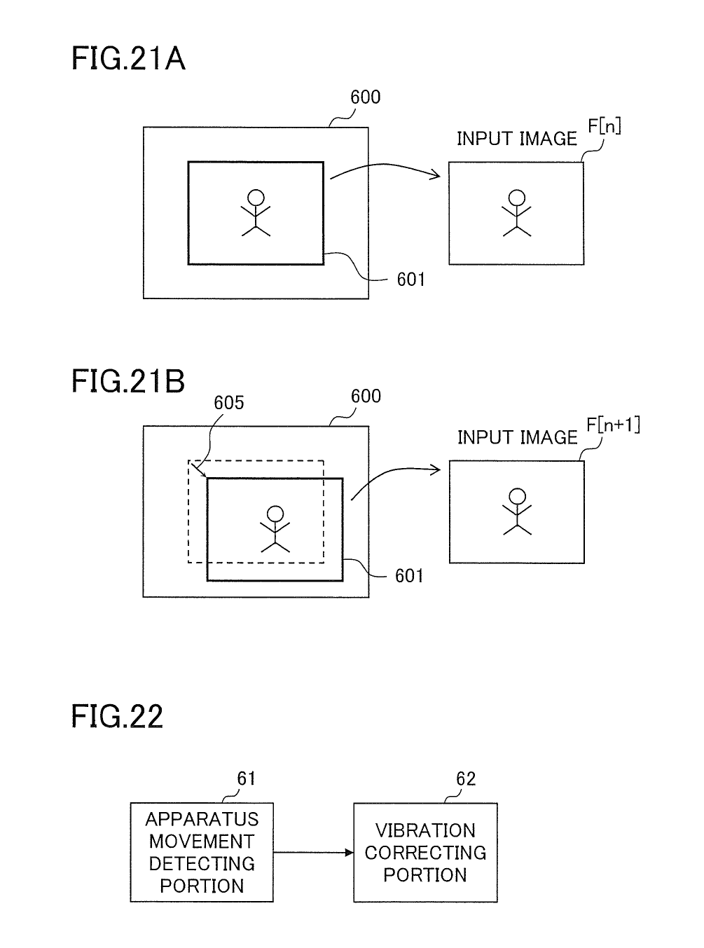

First, with reference to FIGS. 21A and 21B, the electronic vibration correction performed in the image pickup apparatus 1 is described below. In FIG. 21A and the like, a region within a rectangular frame of a solid line denoted by 600 indicates an effective pixel region of the image sensor 33. Note that the region 600 can also be considered to be a memory space on the internal memory 17 in which pixel signals in the effective pixel region of the image sensor 33 are arranged. In the following description, the region 600 is considered to be the effective pixel region of the image sensor 33.

A rectangular extraction frame 601 that is smaller than the effective pixel region 600 is set in the effective pixel region 600, and the pixel signals within the extraction frame 601 are read out so that the input image is generated. In other words, the image within the extraction frame 601 is the input image. In the following description, a position and movement of the extraction frame 601 mean a center position and movement of the extraction frame 601 in the effective pixel region 600.

FIG. 22 illustrates an apparatus movement detecting portion 61 and a vibration correcting portion 62 that can be disposed in the image pickup apparatus 1. The apparatus movement detecting portion 61 detects a movement of the image pickup apparatus 1 from the output signal of the image sensor 33 with a known method. Alternatively, the apparatus movement detecting portion 61 may detect a movement of the image pickup apparatus 1 using a sensor for detecting an angular acceleration or an acceleration of a case of the image pickup apparatus 1. A movement of the image pickup apparatus 1 is caused, for example, by a shake of a hand of the person holding the case of the image pickup apparatus 1. The movement of the image pickup apparatus 1 is also a movement of the image sensor 33.

If the image pickup apparatus 1 moves in the period between the time points tₙ and tₙ₊₁, the noted subject moves on the image sensor 33 and in the effective pixel region 600 even if the noted subject is still in real space. In other words, a position of the noted subject on the image sensor 33 and in the effective pixel region 600 moves in the period between the time points tₙ and tₙ₊₁. In this case, if a position of the extraction frame 601 is fixed, a position of the noted subject in the input image F[n+1] moves from the position of the noted subject in the input image F[n]. As a result, it looks as if the noted subject has moved in the input image sequence constituted of the input images F[n] and F[n+1]. A position change of the noted subject between the input images caused by such a movement, namely the movement of the image pickup apparatus 1 is referred to as an interframe vibration.

A detection result of movement of the image pickup apparatus 1 detected by the apparatus movement detecting portion 61 is referred to also as an apparatus movement detection result. The vibration correcting portion 62 illustrated in FIG. 22 reduces the interframe vibration based on the apparatus movement detection result. The reduction of the inter frame vibration includes complete removal of the interframe vibration. By detecting the movement of the image pickup apparatus 1, an apparatus motion vector indicating a direction and a size of the movement of the image pickup apparatus 1 is determined. The vibration correcting portion 62 moves the extraction frame 601 so that the interframe vibration is reduced based on the apparatus motion vector. A vector 605 illustrated in FIG. 21 B is an inverse vector of the apparatus motion vector between the time points tₙ and tₙ₊₁. In order to reduce the interframe vibration of the input images F[n] and F[n+1], the extraction frame 601 is moved in accordance with the vector 605.

The region within the extraction frame 601 can be referred to also as a vibration correction region. An image within the extraction frame 601 out of the entire image (the entire optical image) formed in the effective pixel region 600 of the image sensor 33 (namely, the image within the vibration correction region) corresponds to the input image. The vibration correcting portion 62 sets, based on the apparatus motion vector, a position of the extraction frame 601 when the input images F[n] and F[n+1] are obtained so as to reduce the interframe vibration of the input images F[n] and F[n+1]. The same is true for the interframe vibration between other input images.

It is supposed that the above-mentioned reduction of the interframe vibration is performed and that the input image sequence 320 (see FIG. 5) is generated. Then, an action of the image processing portion 50 illustrated in FIG. 3 is described below. The apparatus movement detection result during the period while the input image sequence 320 is photographed, which was used for reducing the interframe vibration of the input image sequence 320, is preferably associated with image data of the input image sequence 320 and is recorded in the external memory 18. For instance, when the image data of the input image sequence 320 is stored in the image file and is record in the external memory 18, it is preferred to store the apparatus movement detection result during the period while the input image sequence 320 is photographed, in a header region of the image file.

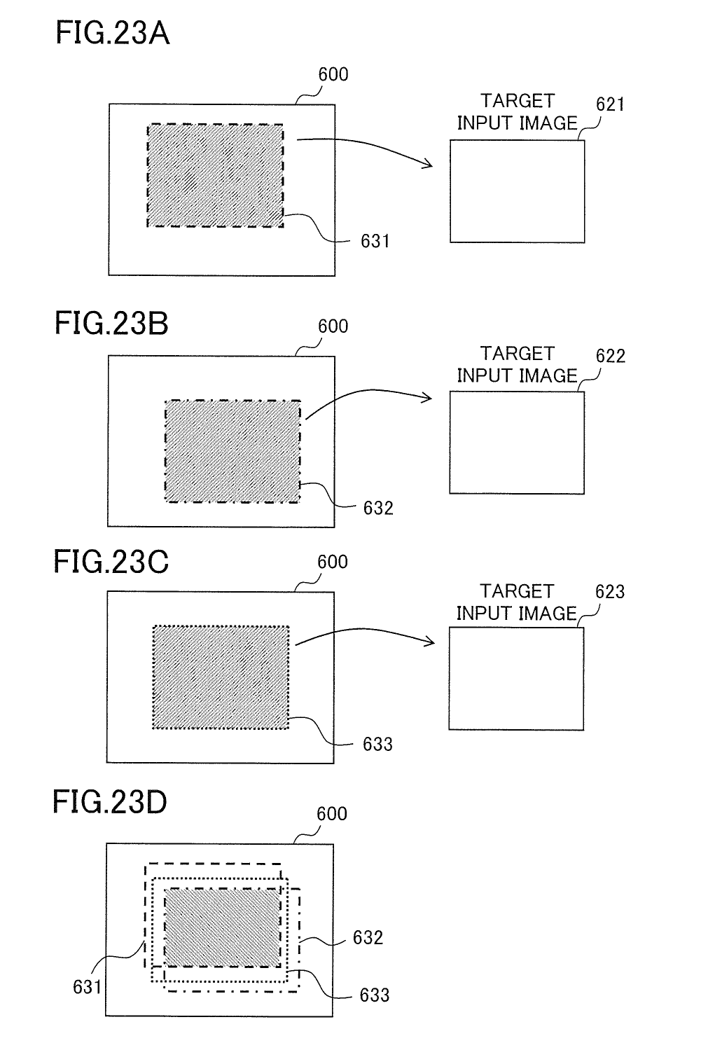

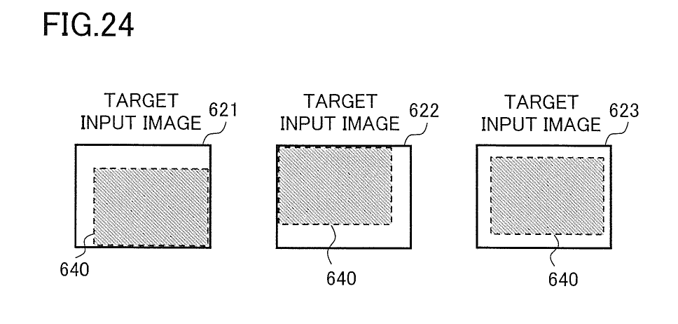

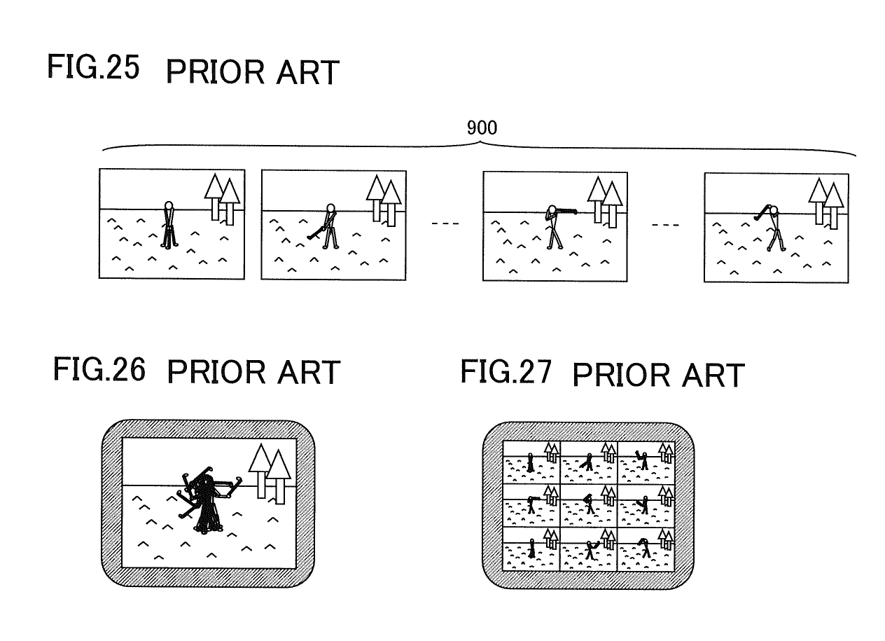

The region setting portion 51 illustrated in FIG. 3 can set the clipping region based on the apparatus movement detection result read out from the external memory 18. Here, with reference to FIGS. 23A to 23D and 24, it is supposed that the plurality of target input images extracted from the input images F[n] to F[n+m] are images 621 to 623. Then, a setting method of the clipping region is described below. In FIGS. 23A to 23C, rectangular regions 631, 632 and 633 with hatching are regions within the extraction frame 601 (the vibration correction region) that are set when obtaining the image data of the target input images 621, 622 and 623, respectively. A region 640 with hatching illustrated in FIG. 23D indicates a region in which the rectangular regions 631 to 633 are overlapped with each other in the effective pixel region 600. The region setting portion 51 can recognize a positional relationship among the rectangular regions 631, 632 and 633 in the effective pixel region 600 based on the apparatus movement detection result read from the external memory 18, and can also detect a position and a size of the overlapping region 640.

The region setting portion 51 sets the clipping regions within the input images 621, 622 and 623 at positions of the overlapping region 640 within the rectangular regions 631, 632 and 633, respectively. In other words, as illustrated in FIG. 24, the region setting portion 51 sets the overlapping region (region with hatching) 640 in the input image 621 to the clipping region of the input image 621, sets the overlapping region (region with hatching) 640 in the input image 622 to the clipping region of the input image 622, and sets the overlapping region (region with hatching) 640 in the input image 623 to the clipping region of the input image 623. The clipping process portion 52 extracts the image within the clipping region in the input image 621 as the clipped image based on the input image 621, extracts the image within the clipping region of the input image 622 as the clipped image based on the input image 622, and extracts the image within the clipping region in the input image 623 as the clipped image based on the input image 623. The method of generating the output combined image from the plurality of clipped images obtained as described above is the same as that described in the first or the second embodiment.

The photographer performs the adjustment of the photographing direction or the like while paying attention to the noted moving object to be included within the clipped image. Therefore, even if the photographing range is changed due to a shake of a hand, at least the noted moving object is usually included in the photographing range. As a result, there is high probability that the overlapping region 640 of each target input image includes image data of the noted moving object. Therefore, in the third embodiment, the overlapping region 640 is set to the clipping region, the clipped images obtained from the clipping regions of the target input images are arranged in the horizontal or the vertical direction and are combined so that the output combined image is generated. Therefore, the same effect as in the first embodiment can be obtained. In other words, because the moving objects at different time points are not overlapped in the output combined image, movement of the moving object can be checked more easily than the stroboscopic image illustrated in FIG. 26. In addition, the moving object is displayed respectively largely in the output combined image. Therefore, movement of the moving object can be checked more easily than the method of FIG. 27 in which multi-display of the frames of the moving image is performed.

### Variations

The embodiments of the present invention can be modified variously as necessary within the range of the technical concept described in the claims. The embodiments described above are merely examples of the embodiments of the present invention, and meanings of the present invention and terms of elements thereof are not limited to those described in the embodiments. The specific numeric values in the above description are merely examples, and they can be changed to various numeric values as a matter of course. As annotations that can be applied to the embodiments described above, Notes 1 to 3 are described below. Descriptions of the individual Notes can be combined arbitrarily as long as no contradiction arises.

[Note 1]

It is possible to form the image processing portion 50 so as to be able to realize a combining mode other than the first and second combining modes according to the first and second embodiments.

[Note 2]

The image processing portion 50 illustrated in FIG. 3 may be disposed in electronic equipment (not shown) other than the image pickup apparatus 1, and the actions described above in the first or second embodiment may be performed in the electronic equipment. The electronic equipment is, for example, a personal computer, a mobile information terminal, or a mobile phone. Note that the image pickup apparatus 1 is also one type of the electronic equipment.

[Note 3]

The image pickup apparatus 1 illustrated in FIG. 1 and the electronic equipment described above may be constituted of hardware or a combination of hardware and software. When the image pickup apparatus 1 and the electronic equipment are constituted using software, a block diagram of a portion realized by software expresses a function block diagram of the portion. In particular, a whole or a part of the functions realized by the image processing portion 50 may be described as a program, and the program may be executed by a program executing device (for example, a computer), so that a whole or a part of the functions can be realized.

What is claimed is:

1. An image processing apparatus comprising:
a region setting portion that sets a clipping region as an image region in each input image based on image data of an input image sequence consisting of a plurality of input images;
a clipping process portion that extracts an image within the clipping region as a clipped image from each of a plurality of target input images included in the plurality of input images; and
an image combining portion that arranges and combines a plurality of clipped images that are extracted.

2. An image processing apparatus according to claim 1, wherein the image combining portion arranges the plurality of clipped images so that the plurality of clipped images are not overlapped with each other when the plurality of clipped images are combined.

3. An image processing apparatus according to claim 2, wherein
the plurality of target input images include first and second target input images,
the clipping region in the first target input image and the clipping region in the second target input image are overlapped with each other, and
the image combining portion arranges the plurality of clipped images so that a clipped image based on the first target input image and a clipped image based on the second target input image are not overlapped with each other when the plurality of clipped images are combined.

4. An image processing apparatus according to claim 1, wherein the region setting portion detects an image region in which a moving object, or an object of specific type, exists based on image data of the input image sequence, and sets the clipping region based on the detected image region.

5. An image processing apparatus according to claim 1, wherein
the plurality of clipped images are arranged and combined so that a combination result image is generated, and
the image combining portion decides an arrangement of the plurality of clipped images based on an aspect ratio or an image size determined for the combination result image.

6. An image processing apparatus according to claim 1, wherein
the image processing apparatus is supplied with a plurality of different input image sequences as the input image sequence,
the region setting portion sets the clipping region for each of the input image sequences,
the clipping process portion extracts the clipped images for each of the input image sequences, and
the image combining portion further arranges and combines a plurality of combination result images in a predetermined direction, which correspond to the plurality of input image sequences, the combination result images being obtained by the combining for each of the input image sequences.

7. An image pickup apparatus which obtains an input image sequence consisting of a plurality of input images from a result of sequential photographing using an image sensor, the image pickup apparatus comprising:
a vibration correcting portion that reduces vibration of subject between the input images due to movement of the image pickup apparatus based on a detection result of the movement;
a region setting portion that sets a clipping region that is an image region in each input image based on the detection result of movement;
a clipping process portion that extracts an image within the clipping region as a clipped image from each of a plurality of target input images included in the plurality of input images; and
an image combining portion that arranges and combines a plurality of clipped images that are extracted.

8. An image pickup apparatus according to claim 7, wherein
an image within a vibration correction region in the entire image formed on the image sensor corresponds to the input image,
the vibration correcting portion reduces the vibration by setting a position of the vibration correction region for each input image based on the detection result of the movement, and
the region setting portion detects an overlapping region of a plurality of vibration correction regions for the plurality of target input images based on the detection result of the movement, and sets the clipping region based on the overlapping region.

9. An image processing method comprising:
a region setting step that sets a clipping region that is an image region in each input image based on image data of an input image sequence consisting of a plurality of input images;
a clipping process step that extracts an image within the clipping region as a clipped image from each of a plurality of target input images included in the plurality of input images; and
an image combining step that arranges and combines a plurality of clipped images that are extracted.

10. A program for a computer to perform the region setting step, the clipping process step and the image combining step according to claim 9.
